(19) United States
(12) Patent Application Publication
(10) Pub. No.: US 2013/0319488 A1
(43) Pub. Date: Dec. 5, 2013

(54) FOLDING WALKER WITH HEIGHT ADJUSTABLE CRUTCHES

(71) Applicant: Johnny J. T. CHIU, New Taipei City (TW)

(72) Inventor: Johnny J. T. CHIU, New Taipei City (TW)

(21) Appl. No.: 13/487,729

(22) Filed: Jun. 4, 2012

(51) Int. Cl. A61H 3/00; A61H 3/02

(52) U.S. Cl. 135/67; 135/68; 135/69

(57) ABSTRACT

A walker is provided with a first side frame including a telescopic forward leg, a telescopic rearward leg, and a top arm having one end integrally formed with the forward leg and the other end joined to the rearward leg; a second side frame including a telescopic forward leg, a telescopic rearward leg, and a top arm having one end integrally formed with the forward leg and the other end joined to the rearward leg; a front frame releasably secured to both the first and second side frames; and first and second crutch sections releasably secured to the first and second side frames respectively.

### BACKGROUND OF THE INVENTION

1. Field of the Invention

The invention relates to walking aids and more particularly to a folding walker having two crutch sections each having a height adjustment mechanism so as to accommodate individuals of different body heights.

2. Description of Related Art

A walker is a two or four-footed frame that elderly or disabled people use as a walking aid (i.e., additional support) to maintain balance or stability while walking. The basic design of a walker is comprised of a frame that is about waist high, approximately 30 cm deep and slightly wider than the user. Typically, walkers are height adjustable and should be set at a height that is comfortable for the user, but will allow the user to maintain a slight bend in their arms. The front two legs of the walker may or may not have wheels attached depending on the strength and abilities of the person using it. It is also common to see casters on the back legs of a walker with wheels on the front.

A conventional walker A is shown in FIG. 1 and comprises two side frames A2 joined together by two traces (not numbered). Each side frame A2 has a handle grip A1 on an intermediate portion of a top transverse member thereof. An inverted U-shaped member B extends upward from both ends of the transverse member of each side frame A2 and has a pad B1. In use, a person may place the pads B1 against the ribcage beneath the armpits and hold the handle grips A1.

However, a number of drawbacks have been found in the conventional walker. In detail, height of the pad B1 is not adjustable, thereby making the walker being difficult of accommodating users of different heights. Further, its forward movement is somewhat difficult due to limited area between the user and the front braces. Raising the walker A to a sufficient height is required prior to forward movement and it may require the user to exert a great force to do so. However, it is difficult for an elderly or disabled people. Further, in use the people may experience a great difficulty when meeting a raised member (e.g., rug) on the floor or when the ground is uneven.

Notwithstanding the prior art, the invention is neither taught nor rendered obvious thereby.

### SUMMARY OF THE INVENTION

It is therefore one object of the invention to provide a walker comprising a first side frame comprising a telescopic forward leg, a telescopic rearward leg, and a top arm having one end integrally formed with the forward leg and the other end joined to the rearward leg; a second side frame comprising a telescopic forward leg, a telescopic rearward leg, and a top arm having one end integrally formed with the forward leg and the other end joined to the rearward leg; a front frame releasably secured to both the first and second side frames; and first and second crutch sections releasably secured to the first and second side frames respectively.

The above and other objects, features and advantages of the invention will become apparent from the following detailed description taken with the accompanying drawings.

### BRIEF DESCRIPTION OF THE DRAWINGS

FIG. 1 is a prospective view of a walker according to the prior art;

FIG. 2 is a prospective view of a folding walker according to the invention;

FIG. 3 is an exploded view of the walker of FIG. 2;

FIG. 4 is a top plan view of the pin-biasing spring;

FIG. 5 depicts front and cross-section of a retaining member;

FIG. 6 is a longitudinal sectional view of the rearward leg and the sliding tube fastened together by the pin-biasing spring and the retaining members;

FIG. 7 is a view similar to FIG. 6 showing a height adjustment operation thereof;

FIG. 8 is a perspective view showing a height adjustment operation of the rearward legs and the crutch sections of the walker of FIG. 2;

FIG. 9 is a view similar to FIG. 2 showing one side frame and one crutch section being pivoted clockwise to be in proximity with the front frame during a folding process; and

FIG. 10 is a view similar to FIG. 9 showing the other side frame and the other crutch section being pivoted counterclockwise to be in proximity with one side frame and one crutch section at the end of the folding process.

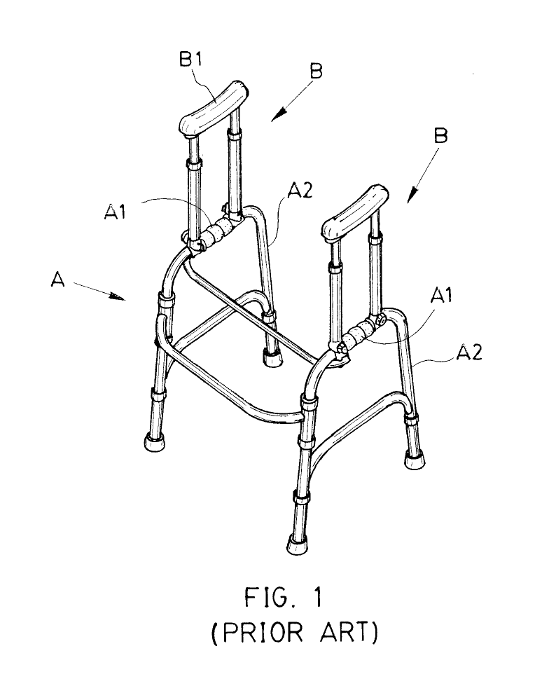

### DETAILED DESCRIPTION OF THE INVENTION

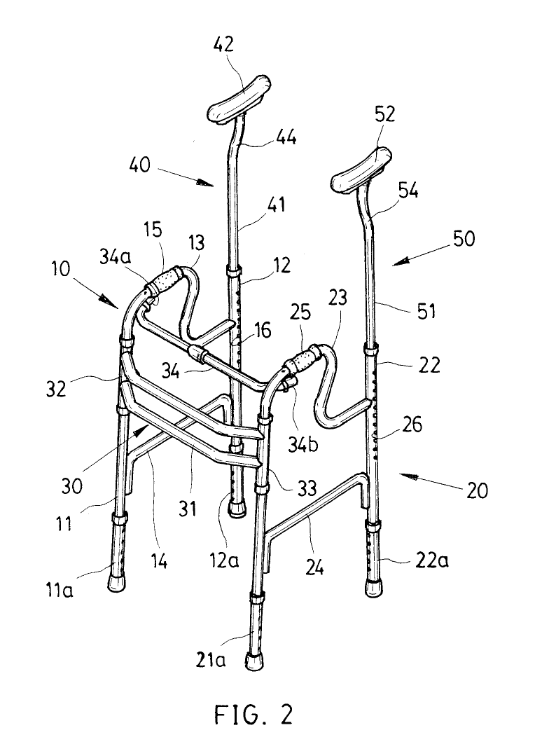

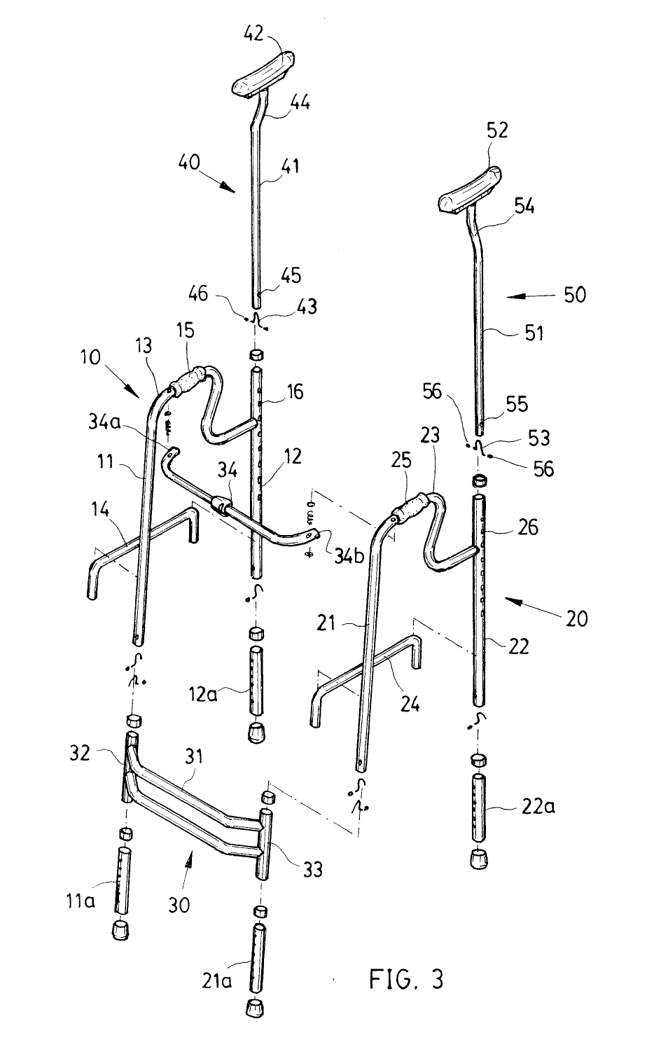

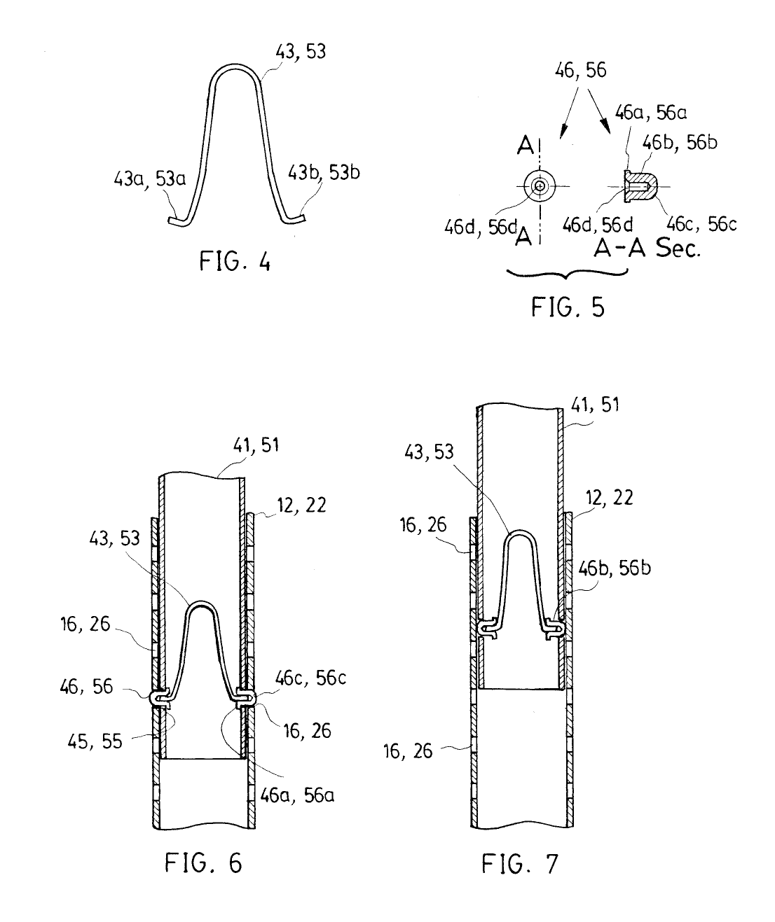

Referring to FIGS. 2 to 10, a folding walker in accordance with the invention comprises the following components as discussed in detail below.

A first side frame 10 comprises a forward leg 11, an rearward leg 12, a bent top arm 13 having one end integrally formed with the forward leg 11 and the other end joined to the rearward leg 12, a padded handle grip 15 secured onto the top arm 13, and an inverted U-shaped lower cross member 14 joined to both the forward leg 11 and the rearward leg 12.

The forward leg 11 comprises a separate support tube 11a being adjustably secured onto a lower portion of the forward leg 11 by means of a known height adjustment mechanism so that the forward leg 11 may be height adjustably disposed on the ground. The rearward leg 12 comprises two opposite groups of a plurality of lock pin receiving apertures 16 along a portion of its length, and a separate support tube 212a being adjustably secured onto a lower portion of the rearward leg 12 by means of a known height adjustment mechanism so that the rearward leg 12 may be height adjustably disposed on the ground.

A second side frame 20, opposite to the first side frame 10, comprises a forward leg 21, an rearward leg 22, a bent top arm 23 having one end integrally formed with the forward leg 21 and the other end joined to the rearward leg 22, a padded handle grip 25 secured onto the top arm 23, and an inverted U-shaped lower cross member 24 joined to both the forward leg 21 and the rearward leg 22.

The forward leg 21 comprises a separate support tube 21a being adjustably secured onto a lower portion of the forward leg 21 by means of a known height adjustment mechanism so that the forward leg 21 may be height adjustably disposed on the ground. The rearward leg 22 comprises two opposite groups of a plurality of lock pin receiving apertures 26 along a portion of its length, and a separate support tube 212a being adjustably secured onto a lower portion of the rearward leg 22 by means of a known height adjustment mechanism so that the rearward leg 22 may be height adjustably disposed on the ground.

A front frame 30 comprises two side tubes 32 with the forward legs 11, 21 freely passing through, two parallel first interconnecting members 31 each having one end joined to one forward leg 11 and the other end joined to the other forward leg 21, and a second interconnecting member 34 having two bent ends 34a, 34b wherein one bend end 34a is releasably secured to the top arm 13 forwardly of the handle grip 15, and the other bend end 34b is releasably secured to the top arm 23 forwardly of the handle grip 25.

A first crutch section 40 comprises a sliding tube 41 having two opposite lock pin receiving holes 45 adjacent to the bottom end; two cup-shaped retaining members 46 each including an annular flange 46a on the mouth, a cylindrical member 46b, a curved bottom 46c, and an interior 46d defined by both the cylindrical member 46b and the bottom 46c wherein the retaining member 46 is disposed in the aligned lock pin receiving hole 45 and the lock pin receiving aperture 16; a pin-biasing spring 43 having two lock pins 43a and 43b at both ends respectively wherein one lock pin 43a is inserted into one retaining member 46 to urge the flange 46a against the inner surface of the sliding tube 41 and slightly project the bottom 46c out of one lock pin receiving aperture 16, and the other lock pin 43b is inserted into the other retaining member 46 to urge the flange 46a against the inner surface of the sliding tube 41 and slightly project the bottom 46c out of the other lock pin receiving aperture 16, thereby locking the rearward leg 12 and the sliding tube 41 (see FIG. 6); a bent arm 44 having one end integrally with the sliding tube 41; and a padded top support 42 having a bottom secured to the other top end of the bent arm 44.

A second crutch section 50 comprises a sliding tube 51 having two opposite lock pin receiving holes 55 adjacent to the bottom end; two cup-shaped retaining members 56 each including an annular flange 56a on the mouth, a cylindrical member 56b, a curved bottom 56c, and an interior 56d defined by both the cylindrical member 56b and the bottom 56c wherein the retaining member 56 is disposed in the aligned lock pin receiving hole 55 and the lock pin receiving aperture 26; a pin-biasing spring 53 having two lock pins 53a and 53b at both ends respectively wherein one lock pin 53a is inserted into one retaining member 56 to urge the flange 56a against the inner surface of the sliding tube 51 and slightly project the bottom 56c out of one lock pin receiving aperture 26, and the other lock pin 53b is inserted into the other retaining member 56 to urge the flange 56a against the inner surface of the sliding tube 51 and slightly project the bottom 56c out of the other lock pin receiving aperture 26, thereby locking the rearward leg 22 and the sliding tube 51 (see FIG. 6); a bent arm 54 having one end integrally with the sliding tube 51; and a padded top support 52 having a bottom secured to the other top end of the bent arm 54.

A height adjustment operation of the first crutch section 40 is discussed in detail below. An individual may user both hands to press the bottoms 46c of the retaining members 46 until the retaining members 46 clear the lock pin receiving apertures 16, thereby compressing the pin-biasing spring 43 and unlocking the rearward leg 12 and the sliding tube 41. Next, the individual may pull the sliding tube 41 upward with the bottoms 46c of the retaining members 46 sliding along an inner surface of the rearward leg 12 (see FIG. 7). The retaining members 46 partially fall in immediate next lock pin receiving apertures 16 due to the expansion of the pin-biasing springs 43 when the retaining members 46 arrive at the immediate next lock pin receiving apertures 16.

The individual may repeat the operation in above paragraph if above position is not what he/she wants until a desired height of the first crutch section 40 is obtained.

Likewise, a height adjustment operation of the second crutch section 50 is discussed in detail below. An individual may user both hands to press the bottoms 56c of the retaining members 56 until the retaining members 56 clear the lock pin receiving apertures 26, thereby compressing the pin-biasing spring 53 and unlocking the rearward leg 22 and the sliding tube 51. Next, the individual may pull the sliding tube 51 upward with the bottoms 56c of the retaining members 56 sliding along an inner surface of the rearward leg 22 (see FIG. 7). The retaining members 56 partially fall in immediate next lock pin receiving apertures 26 due to the expansion of the pin-biasing springs 53 when the retaining members 56 arrive at the immediate next lock pin receiving apertures 26.

The individual may repeat the operation in above paragraph if above position is not what he/she wants until a desired height of the second crutch section 50 is obtained. It is understood that the height of the first crutch section 40 should be equal to that of the second crutch section 50.

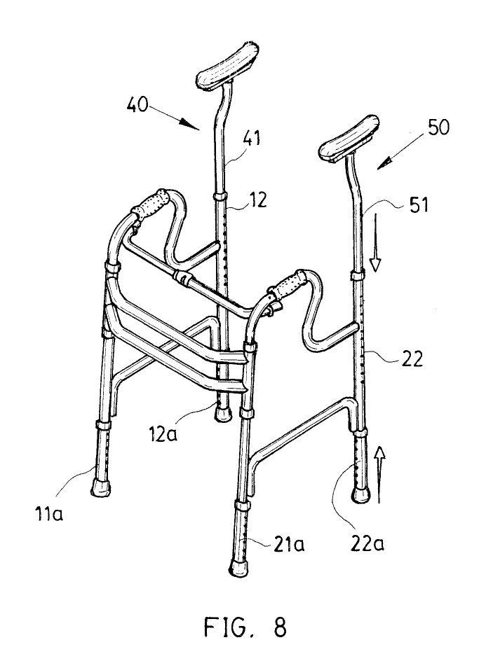

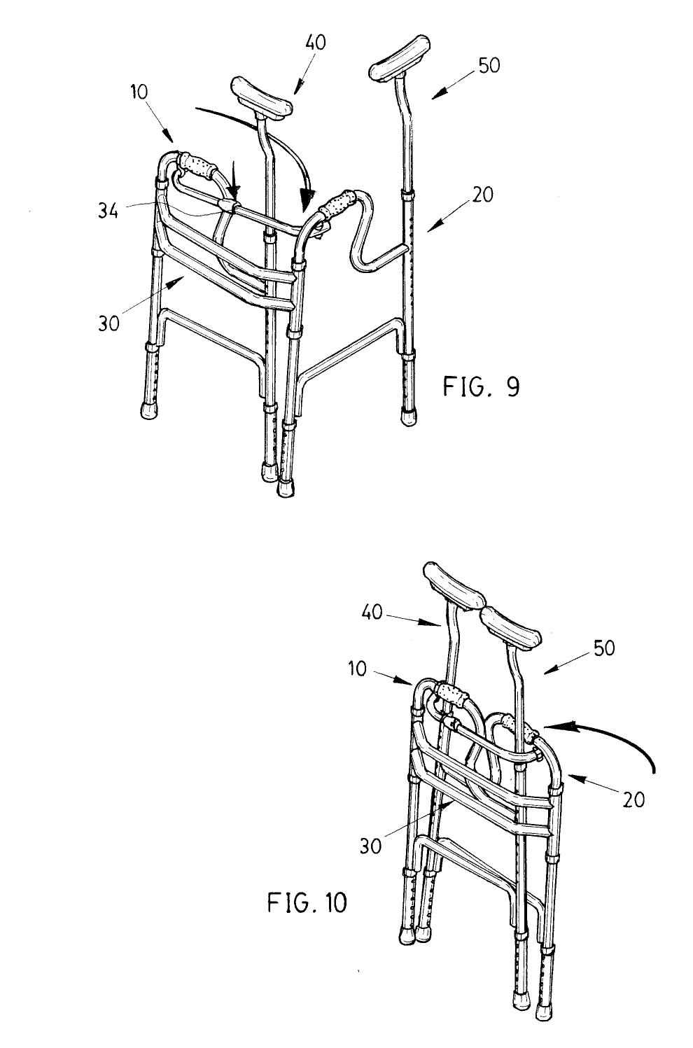

A folding operation of the walker is discussed in detail below by referring to FIGS. 8-10 specifically. First, heights of the rearward legs 12, 22 and the first, second crutch sections 40, 50 are adjusted to a minimum by performing the height adjustment operations (see FIG. 8). Next, the individual may unfasten the front frame 30 so that the first side frame 10 and the first crutch section 10 may be pivoted clockwise to be in proximity with the front frame 30 (see FIG. 9). Finally, the individual may pivot the second side frame 20 and the second crutch section 50 counterclockwise to be in proximity with the first side frame 10 and the first crutch section 40 at the end of the folding operation (see FIG. 10). As a result, the walker is folded to be stored or carried.

The provision of the first, second crutch sections 40, 50, as underarm crutches, allow people with temporary disability or injury to use by placing the padded supports 42, 52 against the ribcage beneath the armpits and holding the handle grips 15, 25. Further, the first, second crutch sections 40, 50 are telescopic so as to accommodate people with different body heights.

While the invention has been described in terms of preferred embodiments, those skilled in the art will recognize that the invention can be practiced with modifications within the spirit and scope of the appended claims.

1. A walker comprising:
a first side frame comprising a forward leg being telescopic, a rearward leg being telescopic, and a top arm having one end integrally formed with the forward leg and the other end joined to the rearward leg;
a second side frame comprising a forward leg being telescopic, a rearward leg being telescopic, and a top arm having one end integrally formed with the forward leg and the other end joined to the rearward leg;
a front frame releasably secured to both the first side frame and the second side frame; and
a first crutch section and a second crutch section releasably secured to the first side frame and the second side frame respectively;
wherein the first crutch section has a sliding tube having a first end inserted into the rearward leg of the first side frame and a second end having a bent arm; and
wherein the second crutch section has a sliding tube having a first end inserted into the rearward leg of the second side frame and a second end having a bent arm.

2. The walker of claim 1, wherein both the first side frame and the first crutch section are capable of pivoting to be in close proximity to the front frame in response to unfastening the first side frame, and both the second side frame and the second crutch section are capable of pivoting to be in close proximity to the front frame in response to unfastening the second side frame.

3. The walker of claim 1, wherein the first crutch section is telescopically secured to the rearward leg of the first side frame, and the second crutch section is telescopically secured to the rearward leg of the second side frame respectively.

4. The walker of claim 1, further comprising a first padded top support and a second padded top support, the first padded top support has a bottom connected to the bent arm of the sliding tube of the first crutch section and the second padded top support has a bottom connected to the bent arm of the sliding tube of the second crutch section.
